(19) United States
(12) Patent Application Publication
(10) Pub. No.: US 2020/0324430 A1
(43) Pub. Date: Oct. 15, 2020

(54) CUTTING-OFF MACHINE FOR THE CUTTING OF LOGS OF SHEET MATERIAL AND RELATIVE CUTTING METHOD

(71) Applicant: PAPER CONVERTING MACHINE COMPANY ITALIA S.P.A., Fornaci di Barga (Lucca) (IT)

(72) Inventors: Giovanni BERTOLI BARSOTTI, Fornaci di Barga (Lucca) (IT); Luca TAGLIASACCHI, Fornaci di Barga (Lucca) (IT)

(21) Appl. No.: 16/380,659

(22) Filed: Apr. 10, 2019

(51) Int. Cl. B26D 7/08; B26D 1/00; B26D 3/16; B26D 1/15

(52) U.S. Cl. CPC B26D 7/086; B26D 1/0006; B26D 3/16; B26D 7/12; B26D 2001/006; B26D 2001/0053; B26D 1/15

(57) ABSTRACT

Disclosed is a cutting-off machine for cutting logs of sheet material, including at least one cutting blade placed on a plane perpendicular to the axis of the logs, in order to perform transverse cuts over the same and produce rolls of smaller length than the logs, wherein the at least one cutting blade is associated with an ultrasonic device apt to generate a vibrating force on the blade.

### BACKGROUND OF THE INVENTION

### Field of the Invention

The present invention relates in general to the production of rolls of sheet material and more particularly to a cutting-off machine and a method for the cutting of logs or sticks of sheet material, in particular paper.

### Description of the Related Art

Traditionally the manufacture of rolls of materials in sheet form, such as toilet paper, tissue paper, kitchen paper and similar products requires a plurality of process stages, comprising the unwinding of the sheet material from a roll of large diameter and rewinding, possibly on a core, to form logs or sticks of smaller diameter, cutting of the logs into rolls of the required length, on the basis of their end use, and packaging of the rolls.

Cutting of the logs for forming rolls of smaller length is carried out with special cutting-off machines which have one or more metal or ceramic blades, of the disc type, which are made to rotate in an orbit around an axis in a cutting plane transverse to the direction of feeding of the log, or of the band type, which are cyclically lowered onto the log to be cut.

The logs are made to move forwards, normally in several parallel channels, towards the cutting blade, pushed by special pushers of a drive chain transferred on transfer wheels.

Another type of cutting-off machine provides for a series of fixed flat blades against which the logs are driven in a direction perpendicular to their axes, so as to be “sliced”.

A problem which reduces, even drastically, productivity of the cutting-off machines is overheating and the consequent deformation of the cutting blade.

Since the cutting blade (in the case of disc blades) for performing the cutting of the log has to have a high rotation speed, during cutting, between the surface of the blade and that of the log to be cut, a high friction is generated which causes excessive overheating of the blade. Having reached a limit temperature, variable in accordance with the material and the shape of the disc of the blade, a relaxation and thermal expansion of the material of the disc occur which lead to deformation of the same disc.

This deformation is due to the residual tensions induced in the disc of the blade in the phase of manufacture to make its surface take on the required planarity.

Consequently, having achieved a limit of deformation of the blade, cutting of the logs has to be interrupted to allow cooling thereof, otherwise the excessively hot blade could deform further, becoming damaged or even broken, without mentioning the poor quality of the cut which is produced.

Cutting-off machines are therefore equipped with systems aiming to lower the temperature of the blade or to control deformation thereof, as occurs in the patent EP 1609570 B1 of the same Applicant, or to ascertain the quality of the cut.

U.S. Pat. No. 3,468,203 describes an apparatus for cutting a strip of flexible material by means of a knife which is pushed elastically against the web while the latter advances continuously in order to be wound on a spindle. In order to improve the cutting effect means are provided to vibrate the knife in the range of sonic or ultrasonic frequencies.

There is therefore the need for a cutting-off machine which overcomes the limits of known machines.

### SUMMARY OF THE INVENTION

The object of the invention is in fact that of providing such a cutting-off machine which eliminates, or at least reduces, the disadvantages of the cutting-off machines of the prior art.

More particularly an object of the invention is that of providing a cutting-off machine which allows cuts to be made of high quality, avoiding overheating and deformation of the cutting blade.

Another object of the invention is that of providing such a cutting-off machine wherein the cutting blade does not require frequent sharpening.

Yet another object of the invention is that of providing a cutting-off machine of any one of the known types, which requires minimum modifications to achieve the abovementioned results.

These and other objects of the invention are achieved by the cutting-off machine according to the invention.

Substantially the cutting-off machine for the cutting of logs of sheet material according to the invention comprises at least one cutting blade placed on a plane perpendicular to the axis of the logs, in order to perform transverse cuts over the same and produce rolls of smaller length with respect to the logs, said at least one cutting blade being associated with an ultrasonic device apt to generate a vibrating force on the blade.

### BRIEF DESCRIPTION OF THE DRAWINGS

Further features of the invention will be made clearer by the following detailed description, referred to its embodiments purely by way of a non-limiting example and illustrated in the accompanying drawings, in which:

FIGS. 1 and 2 are respectively a front view and a side view of a cutting-off machine with rotating disc blade mounted on orbiting arm, provided with a system of ultrasounds according to the invention applied at the centre of the blade;

FIGS. 3 and 4 are respectively a perspective view and front view of a cutting-off machine similar to that of the preceding drawings, with the ultrasounds applied on the edge of the blade;

FIG. 5 is a schematic perspective view of a cutting-off machine with two flat blades mounted on a rotating support, with ultrasounds applied at the bases of the blades; and

FIGS. 6, 7 and 8 are, respectively, a schematic perspective view, a front view and a side view of a cutting-off machine with multiple flat blades for “passing” cutting of the logs, with ultrasounds applied at the bases of the blades.

### DESCRIPTION OF THE PREFERRED EMBODIMENTS

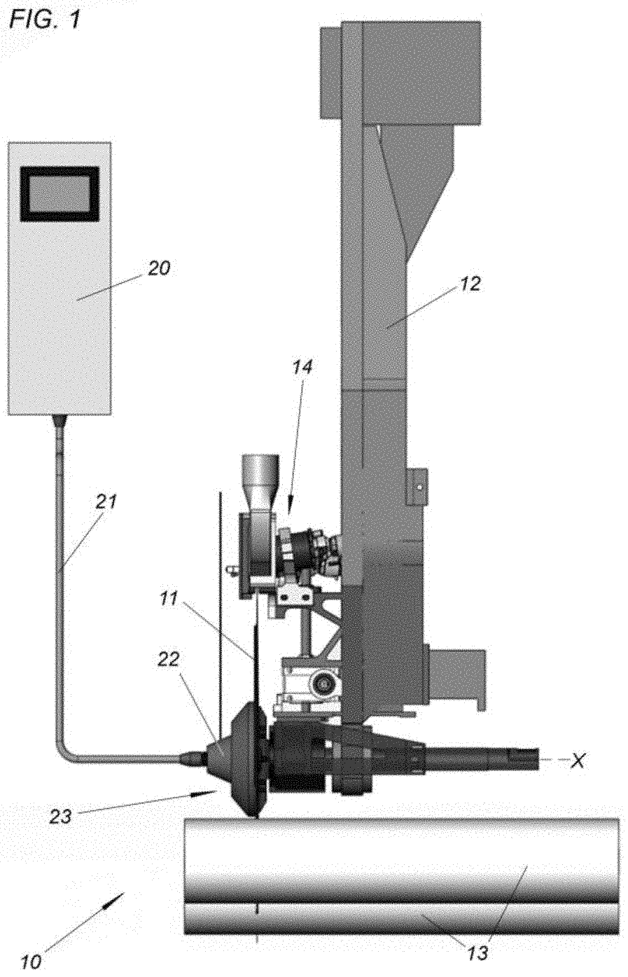

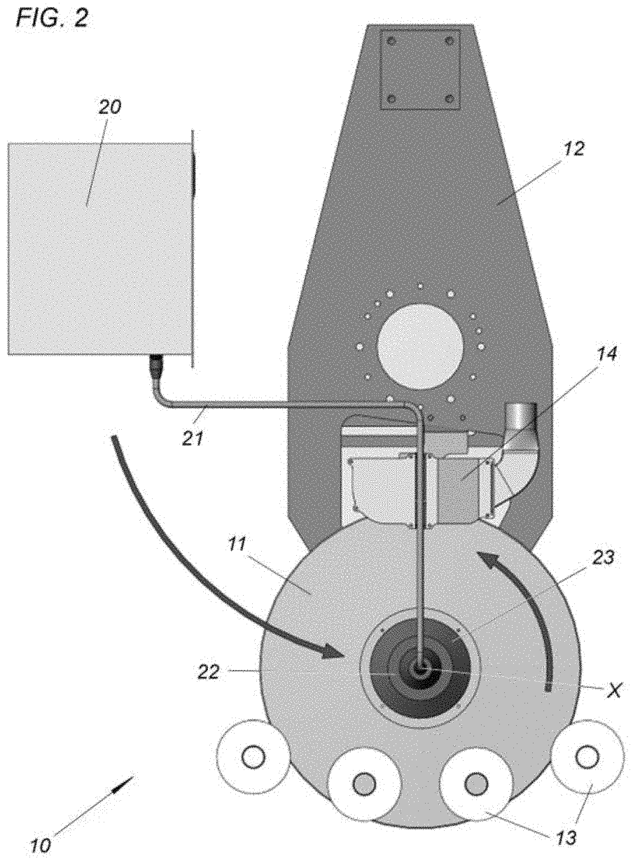

Referring to the accompanying drawings, and for the time being to FIGS. 1 and 2, a cutting-off machine for logs in sheet material, in particular paper, is shown schematically, denoted overall by reference numeral 10.

The cutting-off machine 10 is of the standard type, with rotating disc blade 11, mounted on an orbiting arm 12 so that the blade performs an orbit in a cutting plane perpendicular to the axis of the logs, denoted by reference numeral 13.

According to the embodiment of FIGS. 1 and 2, the logs 13 are made to move forwards in the direction of their axes in order to be taken under the cutting blade 11. Obviously, several cutting blades can be provided.

The drawings also show schematically a sharpening assembly 14 apt to sharpen periodically, and on indication of special sensors, the blade 11 as the latter wears out, if manufactured for example in metal. However, for what is stated here below, with the systems adopted by the invention, the wear of the blade is considerably reduced. Moreover, if special blades are used, for example in titanium, the sharpening assembly 14 can be absent.

According to the invention the cutting-off machine 10 is equipped with an ultrasonic device for causing the blade 11 to vibrate and improve the cut, eliminating the disadvantages illustrated previously.

The ultrasonic device, in the schematic form shown, comprises a generator of ultrasounds 20, connected by means of a cable 21, to an ultrasonic converter 22, coupled to a sonotrode 23.

However, the sonotrode could be part of the mechanism responsible for the rotation of the blade.

The ultrasonic converter 22 converts the electrical energy with frequency coming from the generator 20 into mechanical vibrations with high frequency, which are transferred to the sonotrode 23, which transmits the vibratory energy to the blade 11.

In the embodiment of FIGS. 1 and 2 the sonotrode 23 is mounted on the axis X of the blade 11, so that the ultrasounds are applied at the centre of the blade.

The provision of the ultrasounds, which make the blade vibrate, allows a very precise cut of the logs 13 to be made, avoiding overheating of the blade thanks to the reduced cutting force required by the vibration of the blade. The logs are not therefore deformed by the compression.

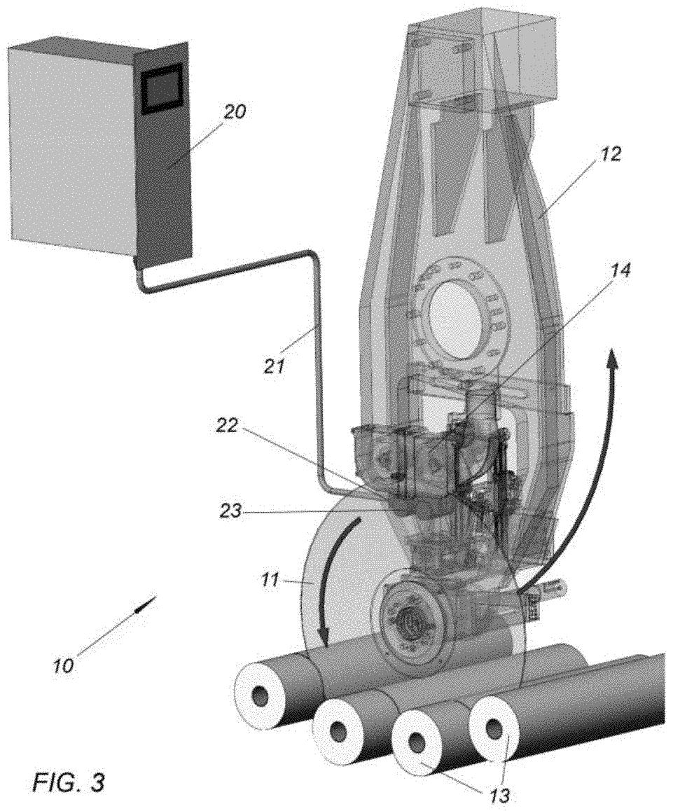

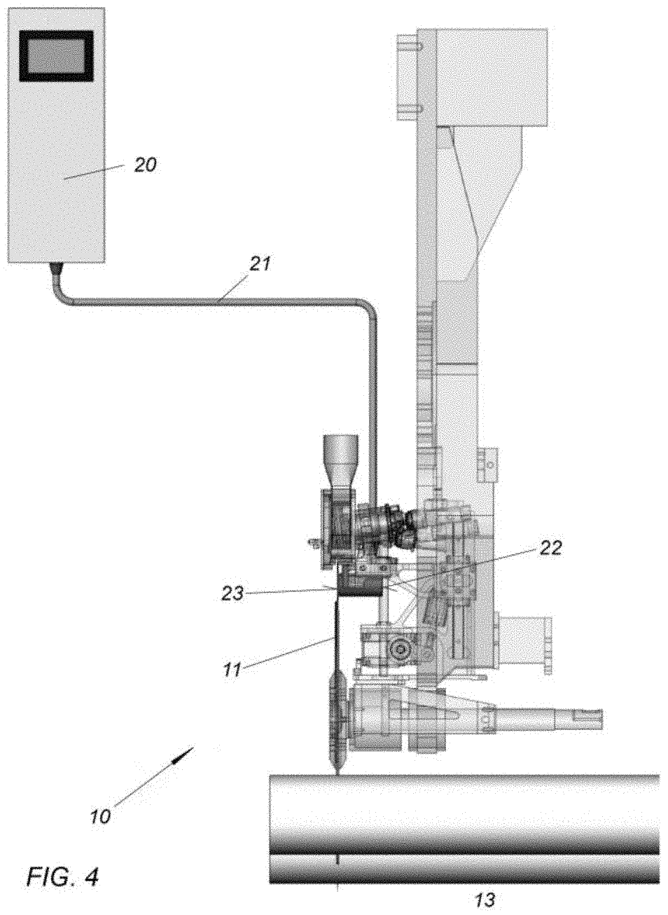

FIGS. 3 and 4, in which the same reference numerals introduced previously are used, illustrate an embodiment of the cutting-off machine wholly similar to that of FIGS. 1 and 2.

The only difference is that in this case the ultrasonic converter 22 and the sonotrode 23 are applied in proximity of the edge of the blade. Therefore, the vibratory force of the ultrasounds acts directly on the edge of the blade. Without departing from the scope of the invention, one or more sonotrodes can be provided, placed paraxial to the axis of the disc between the centre and the edge of the disc blade (11).

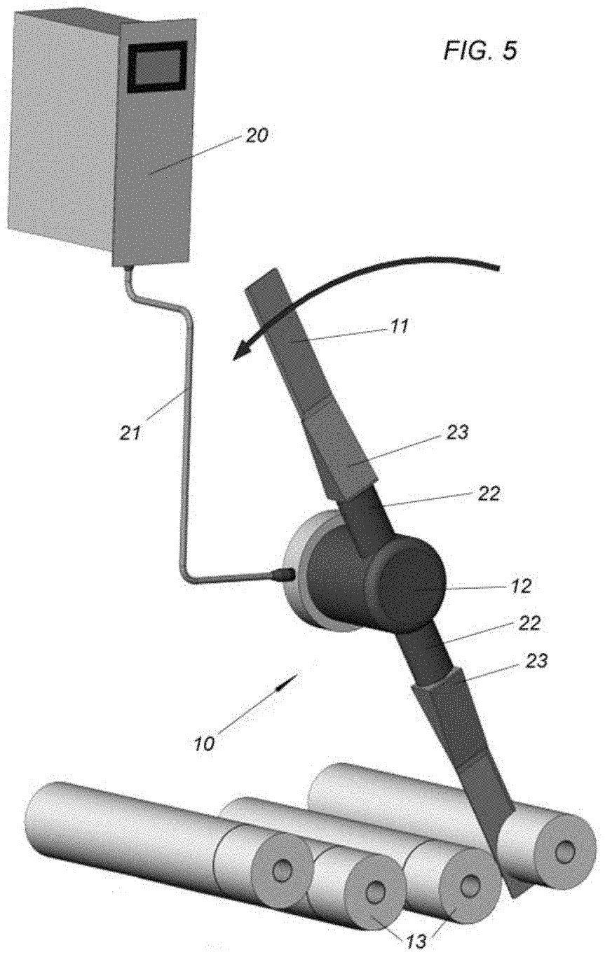

According to the embodiment of FIG. 5, the cutting-off machine comprises on purpose shaped flat blades, in particular two rectilinear flat blades 11 placed in diametrically opposed positions on a rotating support 12.

In this case the sonotrodes 23 are placed at the base of the blades 11.

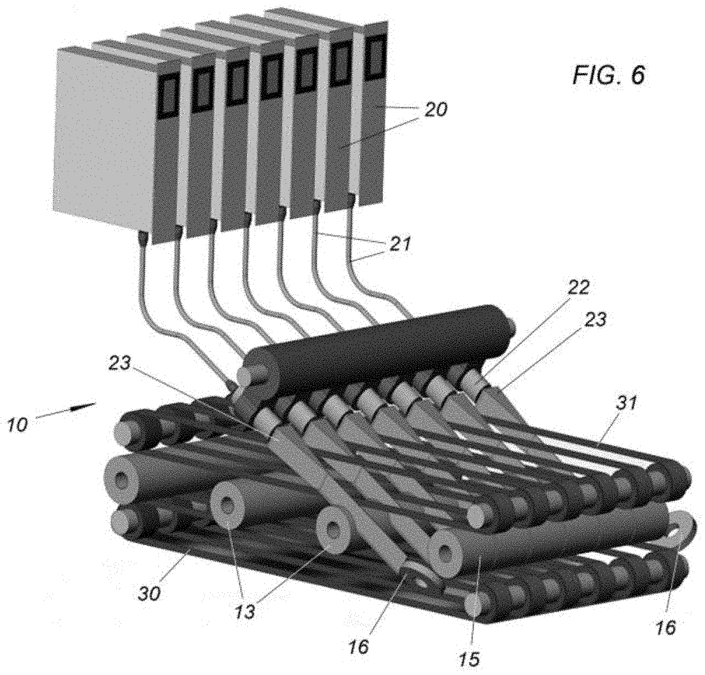

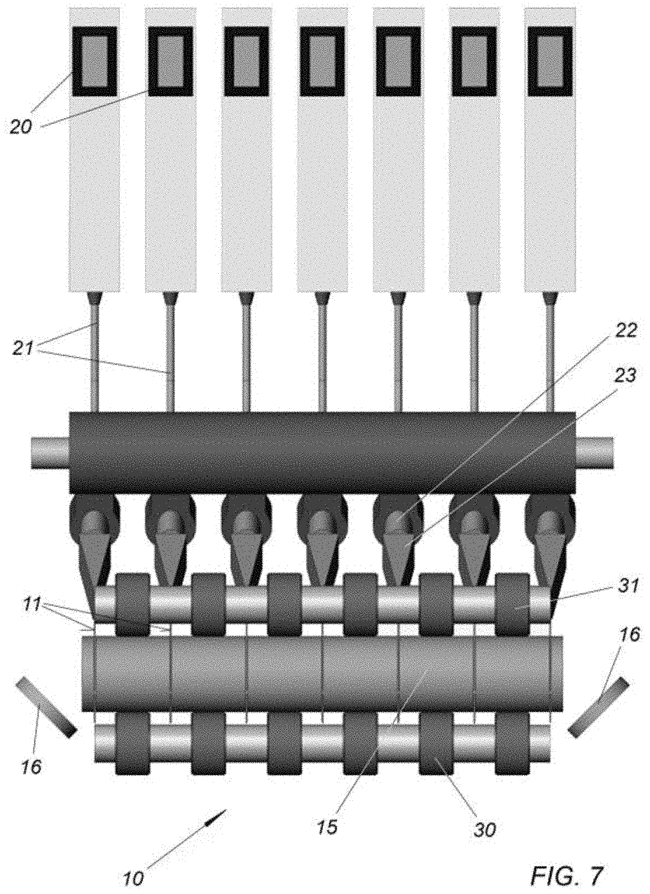

According to the embodiment of FIGS. 6, 7 and 8, a plurality of fixed flat blades 11 are provided, against which the logs 13 are made to move forwards in a direction perpendicular to their axes, for a so-called “passing” cut.

For the transport of the logs a plurality of lower drive belts 30 are provided, and a corresponding plurality of opposite upper drive belts 31, placed between the plurality of blades 11.

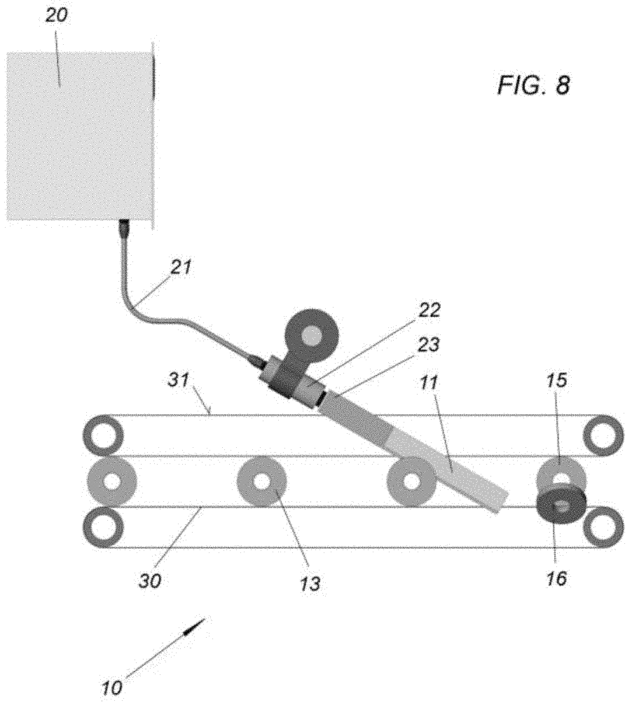

In FIGS. 6 and 8, two logs moving forwards towards the cutting blades 11 are shown between the opposite series of belts 30, 31, one log at the cutting stage and one log already cut into rolls 15, with side trims 16.

In this case a plurality of ultrasounds generators 20 are provided, connected by means of respective cables 21 to corresponding ultrasonic converters 22 and sonotrodes 23 placed at the bases of the respective blades 11.

From what has been disclosed the advantages appear clear of the invention which, combining an ultrasonic device with a cutting-off machine of logs of sheet material of any known type, allows an extremely precise cut to be obtained, eliminating the disadvantages of the prior art linked to the overheating and deformation of the cutting blade.

Naturally the invention is not limited to the particular embodiments previously described and illustrated in the accompanying drawings, but numerous detailed changes may be made thereto, within the reach of the person skilled in the art, without thereby departing from the scope of the invention itself as defined by the appended claims.

1. Cutting-off machine (10) for cutting logs (13) of sheet material, comprising at least one cutting blade (11) placed on a plane perpendicular to the axis of the logs (13), in order to perform transverse cuts over the same and produce rolls (15) of smaller length than the logs, characterised in that said at least one cutting blade (11) is a rotating blade, with which is associated at least one sonotrode (23) of an ultrasonic device apt to transmit vibrational energy to the blade.

2. Cutting-off machine according to claim 1, wherein said rotating blade (11) is a disc carried by an orbiting arm, and said sonotrode (23) is placed on the axis (X) of the disc blade (11).

3. Cutting-off machine according to claim 1, wherein said rotating blade (11) is a disc carried by an orbiting arm (12), and said at least one sonotrode (23) is placed paraxial to the axis of the disc between the centre and the edge of said disc blade (11).

4. Cutting-off machine according to claim 1, wherein said rotating blade (11) is constituted by on purpose shaped flat blades (11) diametrically opposed, carried by a rotating support (12), and said sonotrode (23) is placed in correspondence to the base of the corresponding blade.

5. Cutting-off machine according to claim 1, characterised in that said ultrasonic device comprises an ultrasonic generator (20) linked by means of a cable (21) to an ultrasonic converter (22) and to said sonotrode (23) placed on the blade (11).

6. Cutting-off machine according to claim 1, wherein said sonotrode is a part of the mechanism responsible for the rotation of the blade.

7. Method for cutting logs (13) of sheet material by means of a cutting-off machine having at least one cutting blade (11) placed on a plane perpendicular to the axis of the logs, consisting in carrying said at least one blade into contact with said logs, or vice versa said logs into contact with said at least one blade to perform transverse cuts over the logs and to produce rolls (15) of smaller length than the logs, characterised in that said at least one cutting blade (11) is a rotating blade and ultrasounds are applied thereon during the cutting operation.

8. Method according to claim 7, wherein said rotating blade (11) is a disc carried by an orbiting arm (12) and said ultrasounds are applied on the axis (X) of the disc or in proximity of its edge.

9. Method according to claim 7, wherein said at least one rotating cutting blade (11) is constituted by on purpose shaped flat blades diametrically opposed and said ultrasounds are applied at the base of the respective blade.
